(19) United States
(12) Patent Application Publication
(10) Pub. No.: US 2013/0065931 A1
(43) Pub. Date: Mar. 14, 2013

(54) METHODS FOR REDUCING WIREWORM DAMAGE TO CROPS

(71) Applicants: John Bell, Chapel Hill, NC (US); Kelvan R. Luff, Kimberly, ID (US); Philip John Sarasqueta, Twin Falls, ID (US)

(72) Inventors: John Bell, Chapel Hill, NC (US); Kelvan R. Luff, Kimberly, ID (US); Philip John Sarasqueta, Twin Falls, ID (US)

(21) Appl. No.: 13/624,017

(22) Filed: Sep. 21, 2012

Related U.S. Application Data
(60) Provisional application No. 61/570,452, filed on Dec. 14, 2011.

(51) Int. Cl. A01N 43/38; A01P 15/00

(52) U.S. Cl. 514/409

(57) ABSTRACT

Methods and compositions for controlling pests of the order Coleoptera are described herein. Methods of reducing wireworm damage in potatoes by applying a compound or composition disclosed herein in a foliar treatment is also described.

### CROSS-REFERENCE TO RELATED APPLICATIONS

This application claims the benefit of U.S. Provisional Patent Application Ser. No. 61/370,452, filed Dec. 14, 2011, the contents of which are herein incorporated by reference in their entirety.

### FIELD

Methods for reducing damage and losses in plant health, vigor, quality and yield caused by pests of the order Coleoptera and the family Elateridae are described herein. The disclosure also provides for methods of reducing wireworm damage in crops or plants by applying a compound disclosed herein to a crop or plant in need thereof.

### BACKGROUND

Wireworm infestation leads to substantial crop loss, resulting in significant economic losses. Wireworms are the subterranean larval stage of click beetles (order of Coleoptera; family of Elateridae) and are pests of many agricultural crops including corn, sorghum, small grains, tobacco, sugar beets, beans, various vegetables, and potatoes. Wireworms are particularly damaging to potatoes, since the marketable portion of that crop is present in the soil, which is where wireworms feed and complete much of their life cycle.

Wireworms feed on soil insects as well as the roots of grass and weeds. In an agricultural setting where land has been cultivated, wireworms seek out underground portions of planted crops. Wireworms may injure potatoes by feeding on the seed piece resulting in weak stands, but the majority of damage is caused by tunneling into tubers, which reduces yield and tuber quality. Wireworm tunneling also creates an entry point for certain plant pathogens. Such an event can lead to other harmful conditions such as tuber rot.

Wireworms often spend multiple years in the soil and a complete life cycle from egg to adult generally require 1 to 4 years but may take up to 8 years depending on environmental conditions and wire worm species. Wireworms are very difficult to eradicate as long as there is a crop or native host plant for food. Wireworms remain in the soil for the entire larval period progressing through multiple developmental stages.

Wireworms are major pests to potatoes. For over 25 years, potato growers have struggled to find efficacious and cost effective control for wireworm infestation. Examples of soil-applied compounds used to control infestation include ethoprop (MOCAP®), phorate (THIMET®), pyrethroid bifenthrin (CAPTURE®), and phenylpyrazole fipronil (REGENT®). These compounds are typically applied to soil regions as preplant or at plant soil placements and cannot be effectively applied to some crops like potatoes after plant emergence. Currently, there are no products known to effectively control wireworms by foliar application.

Therefore, there is a need to control, treat, or inhibit damage in plants or crops in need thereof, especially wireworm damage in potatoes via a foliar application.

### SUMMARY

One aspect relates to a method for reducing or inhibiting Coleoptera pest damage to a crop susceptible to Coleoptera pest damage including applying spirotetramat to a crop susceptible to Coleoptera pest damage. Another aspect relates to a method for repelling a Coleoptera pest including applying spirotetramat to a crop susceptible to Coleoptera pest damage.

In another aspect, the spirotetramat-based composition is applied to a foliar region of a crop susceptible to Coleoptera pest damage. Another aspect also provides that a crop susceptible to Coleoptera pest damage is selected from the group consisting of potatoes, sugar beets, and dry beans. Another aspect relates to an application step spraying, fumigating, chemigating, fogging, scattering, brushing on, treating seed, shanking or injecting.

Another aspect relates to a method for reducing or inhibiting Coleoptera pest damage, wherein spirotetramat is applied to a potato in an amount effective to control wire worms. In an aspect spirotetramat is applied to a potato at about 3 to about 10 fluid ounces per acre per season or to a potato at about 3 to about 6 fluid ounces per acre per application and said Coleoptera pest is a wireworm.

In yet another aspect, spirotetramat is applied to a potato after about 20 days following planting or after about 30 days following planting or about 45 days after planting. The disclosure also provides for a method of applying spirotetramat to a potato plant.
(1) in a first application step after about 35 to about 42 days after planting; and/or
(2) in a second application step after about 45 to about 52 days after planting; and/or
(3) in a third application step after about 55 to about 62 days after planting, and/or
(4) in a fourth application step after about 65 to about 72 days after planting.

### BRIEF DESCRIPTION OF THE FIGURES

FIG. 1 sets forth the percent of wireworm infected potato tubers after treatment with compositions described herein, “DAP” refers to the number of “days after planting.”

FIG. 2 sets forth the number of wireworm entries per potato tuber at midseason (88 days) and at harvest (149 days) after treatment with compounds or compositions described herein.

FIG. 3 sets forth the percent reduction of wireworm infestation on potatoes. A refers to at planting; B refers to 42 days after planting; C refers to 49 days after planting; D refers to 68 days after planting; and E refers to 82 days after planting.

FIG. 4 sets forth greenhouse trials showing the percentage of potato tubers exhibiting tunnels.

FIG. 5 sets forth greenhouse trials showing the percentage of potato tubers exhibiting skin feeding damage.

FIG. 6 sets forth greenhouse trials showing the number of larvae recovered after potato treatments and reported as the mean of 4 pots per treatment per 10 larvae per pot.

FIG. 7 sets forth greenhouse trials showing the number of dead larvae recovered after potato treatments and reported as the mean of 4 pots per treatment per 10 larvae per pot.

FIG. 8 sets forth greenhouse trials showing the number of living larvae recovered after potato treatments and reported as the mean of 4 pots per treatment per 10 larvae per pot.

FIG. 9 sets forth greenhouse trials showing the number of tubers with a diameter of <30-35 mm after potato treatments and reported as the mean of 4 pots per treatment.

FIG. 10 sets forth greenhouse trials showing the number of tubers with a diameter of >30-35 mm after potato treatments and reported as the mean of 4 pots per treatment.

FIG. 11 sets forth greenhouse trials showing the number of tubers with a diameter of about 55-60 mm after potato treatments and reported as the mean of 4 pots per treatment.

### DETAILED DESCRIPTION

In an aspect, the disclosure provides for a method of treating a crop, plant, or plant part susceptible to damage or infestation caused by pests of the order Coleoptera. In another aspect, the disclosure provides for a method of reducing or inhibiting damage or infestation caused by pests of the order Coleoptera to a crop, plant, or plant part thereof by applying a compound or composition described herein to a to a crop, plant, or plant part thereof. In yet another aspect, the disclosure provides for a method of repelling a pest of the order Coleoptera by applying a compound or composition described herein to a to a crop, plant, or plant part thereof.

In an aspect, the disclosure provides for a method of reducing or inhibiting wireworm damage to a plant or plant part thereof by applying a compound or composition described herein to a crop, plant, or plant part thereof. In another aspect, the disclosure provides for a method of reducing wireworm damage to a plant or plant part thereof by applying a compound or composition described herein to a crop, plant, or plant part thereof. In an aspect, the crop to be treated is potato.

In an aspect, the disclosure provides for a method of reducing or inhibiting wireworm damage to a potato by applying a composition comprising, consisting of, or consisting essentially of spirotetramat to a potato. In another aspect, the disclosure provides for a method of treating wireworm infestation by applying a composition comprising, consisting of, or consisting essentially of spirotetramat to a potato. In an aspect, treating refers to repelling, killing, or otherwise reducing plant or crop damage or infestation.

In yet another aspect, the disclosure provides for a method of reducing tuber tunneling in a potato by applying a composition comprising, consisting of, or consisting essentially of spirotetramat to a potato. In an aspect, the disclosure provides for a method of reducing tuber skin feeding damage in a potato by applying a composition comprising, consisting of, or consisting essentially of spirotetramat to a potato.

In another aspect, the disclosure provides for a method of repelling a wireworm by applying a composition comprising, consisting of, or consisting essentially of spirotetramat to a potato. In another aspect, the disclosure provides for a method of repelling wireworms, wherein the wireworms are repelled and not killed by the application of a compound or composition described herein. In yet another aspect, the disclosure provides for a method of repelling a wireworm by applying a composition comprising, consisting of, or consisting essentially of spirotetramat to a potato, wherein the wireworm is repelled due to an anti-feeding effect.

In an aspect, the disclosure provides for a method of increasing potato yield by applying a composition comprising, consisting of, or consisting essentially of spirotetramat to a potato.

In an aspect, a compound or composition described herein is applied to a crop, plant, or plant part thereof in any manner sufficient to convey the desired physiochemical property. In another aspect, a compound or composition described herein is applied to a foliar region of a crop, plant, or plant part thereof. In an aspect, any above-ground plant part such as a leaf, flower, needle, stalk, stem, or fruit body is subject to a foliar treatment.

In an aspect, the wireworm species described herein is a juvenile stage of Melanotus spp., Melanotus communis, Conoderus vespertinus, C lividus, Agriotes lineatus, Agnates obseurus, Agriotes sputator L, sugarbeet wireworm (Limonius californicus), pacific coast wireworm (Limonius canus), great basin wireworm (Ctenecera pruinina), Adelocera, Adrastus, Aeoloderma, Aeoloides, Aeolus, Agriotes, Agrypnus, Alaus, Ampedus, Anchastus, Anostirus, Aplotarsus, Athous, Berninelsonius, Betarmon, Brachygonus, Brachylacon, Calambus, Cardiophorus, Chalcolepidus, Cidnopus, Conoderus, Craspedostethus, Crepidophorus, Ctenicera, Dacnitus, Dalopius, Danosoma, Denticollis, Diacanthous, Dicronychus, Dima, Drasterius, Eanus, Ectamenogonus, Ectinus, Elater, Elathous, Eopenthes, Fleutiauxellus, Haterumelater, Hemicleus, Hemicrepidius, Heteroderes, Horistonotus, Hypnoidus, Hypoganus, Hypolithus, Idolus, Idotarmonides, Ischnodes, Isidus, Itodacne, Jonthadocerus, Lacon, Lanelater, Limoniscus, Liotrichus, Megapenthes, Melanotus, Melanoxanthus, Metanomus, Mulsanteus, Negastrius, Neopristilophus, Nothodes, Oedostethus, Orithales, Paracardiophorus, Paraphotistus, Peripontius, Pheletes, Pittonotus, Pityobius, Plastocerus, Podeonius, Porthmidius, Procraerus, Prodrasterius, Prosternon, Pseudanostrius, Pyrophorus, Quasimus, Reitterelater, Selatosomus, Sericus, Simodactylus, Spheniscosomus, Stenagostus, Synaptus, Tetrigus, and Zorochros.

In an aspect, the disclosure provides for one or more tetramic acid derivatives of formula (I) as the actives:

(I)

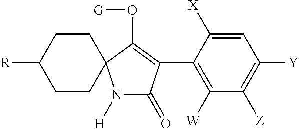

| Compound | | | | | | |
|---|---|---|---|---|---|---|
| No. | W | X | Y | Z | R | G |
| I-1 | H | Br | H | CH₃ | OCH₃ | CO-i-C₃H₇ |
| I-2 | H | Br | H | CH₃ | OCH₃ | CO₂—C₂H₅ |
| I-3 | H | CH₃ | H | CH₃ | OCH₃ | H |
| I-4 | H | CH₃ | H | CH₃ | OCH₃ | CO₂—C₂H₅ |
| I-5 | CH₃ | CH₃ | H | Br | OCH₃ | H |
| I-6 | CH₃ | CH₃ | H | Cl | OCH₃ | H |
| I-7 | H | Br | CH₃ | CH₃ | OCH₃ | CO-i-C₃H₇ |
| I-8 | H | CH₃ | Cl | CH₃ | OCH₃ | CO₂C₂H₅ |
| I-9 | CH₃ | CH₃ | CH₃ | CH₃ | OCH₃ | H |
| I-10 | CH₃ | CH₃ | H | Br | OC₂H₅ | CO-i-C₃H₇ |
| I-11 | H | CH₃ | CH₃ | CH₃ | OC₂H₅ | CO-n-C₃H₇ |
| I-12 | H | CH₃ | CH₃ | CH₃ | OC₂H₅ | CO-i-C₃H₇ |
| I-13 | H | CH₃ | CH₃ | CH₃ | OC₂H₅ | CO-c-C₃H₅ |

In an aspect, the compounds described herein are present in the form of cis/trans isomer mixtures or their pure cis isomers. In another aspect, the compounds of formula (I) are capable of being used with any of the methods described herein.

In yet another aspect, additional compounds capable of being used with any of the methods described herein can be found in U.S. application Ser. No. 12/376,411 or U.S. Pat. No. 6,994,866, the contents of which are incorporated by reference in their entirety.

Spirotetramat, a tetramic acid derivative (ketoenol), is an insecticide whose mode of action is inhibition of lipogenesis in treated insects, resulting in decreased lipid contents, growth inhibition of younger insects, and reduced ability of adult insects to reproduce. In contrast to standard insecticides, spirotetramat is taken up by the plant. It is then carried around within the vascular system of the plant, including into roots and newly-forming shoots. Insect pests ingest the compound which then works by inhibiting lipid biosysnthesis, affecting reproduction in adults and especially juveniles. It has surprisingly been found that such ingestion is not required here, since spirotetramat can also work by repelling even without ingestion.

PCT/US2008/013829, the contents of which are incorporated in their entirety, discloses use of tetramic acid derivatives including but not limited to spirotetramat to reduce the population density of soil-dwelling plant-damaging nematodes in annual and perennial crops after foliar treatment.

In an aspect, compositions capable of being used in soil application steps include THIMET®, DYFONATE®, MOCAP®, ADMIRE PRO®, and Brigadier 2SC. In an aspect, MOVENTO® 240 SC is applied to the foliar region of a crop, plant, or plant part described herein. In an aspect, MOVENTO® 240 SC is applied to the foliar region of a crop, plant, or plant part described herein and THIMET®, DYFONATE®, MOCAP®, ADMIRE PRO®, and Brigadier 2SC are used in an application step.

In an aspect, the methods described herein exclude a soil application step. In another aspect, the methods described herein include a foliar application step and exclude a soil application step. In another aspect, the methods described herein exclude a direct soil application step and the only application of a compound or composition described herein would be to the foliar region of a crop described herein. In yet another aspect, the compounds or compositions described herein are not applied to the root or underground portion of the potato. In an aspect, the exclusion of a soil application step refers to less than about 2%, less than about 5%, less than about 10%, less than about 20%, or less than about 30% of the total percent applied of a compound or composition described herein being applied to soil. In another aspect, a foliar application includes a trace amount of a compound or composition described herein coming into contact with soil. In yet another aspect, any soil application is incidental to foliar treatment.

In an aspect, the methods described herein include a soil or seed application step. In yet another aspect, the description provides for method for reducing or inhibiting Coleoptera pest damage to a crop susceptible to Coleoptera pest damage by applying spirotetramat to the soil or seed of a crop susceptible to Coleoptera pest damage.

In yet another aspect, the disclosure provides tor a method of reducing wireworm damage, a method of treating wireworm infestation, a method of reducing tuber tunneling, a method of reducing tuber skin feeding damage, or a method of repelling a wireworm, wherein the method excludes applying an insecticide, herbicide, or other agricultural chemical agent in a soil application step.

In an aspect, the disclosure provides for a method of applying a soil application step of a compound or composition described herein to a potato crop at planting followed by applying one or more foliar applications of a compound or composition described herein after planting to potato crop. In another aspect, a composition including imidacloprid is applied to a potato crop In a soil application step and a composition including spirotetramat is applied in one or more foliar applications to a potato crop. In yet another aspect, a composition including ADMIRE PRO® is applied to a potato crop in a soil application step and a composition including MOVENTO® is applied in one or more foliar applications to a potato crop. In another aspect, 1,3-dichloropropene (Telonell), 1,3-dichloropropene and chloropicrin (Telone C-17, Telone C-35), ethoprop (Mocap), fipronil (Regent), imidacloprid (Admire Pro), thiamethoxam (Platinum), thaimethoxam (Cruiser 5FS, Cruiser Maxx), phorate (Unmet 20G, Phorate 20G), or bifenthrin (Brigadier) are applied to a potato crop in a soil application step and/or seed treatment step and a composition including MOVENTO® is applied in one or more foliar applications to a potato crop. In an aspect, the disclosure provides for a method of wireworm suppression of daughter tubers by applying a compound or composition described hereon to a potato crop.

In an aspect, the methods disclosed herein reduce damage caused by wire worms by about 40% to about 50% compared to an untreated plant. In another aspect, the methods and compositions disclosed herein reduce damage caused by wire-worms by about 10% to about 20%, about 10 % to about 30%, about 10% to about 40%, about 10% to about 90%, about 20% to about 80%, about 30% to about 70%, about 40% to-about 60%, or about 5% or more, about 10% or more, about 20% or more, about 30% or more, about 40% or more, about 50% or more, about 60% or more, about 70% or more, about 80% or more, or about 90% or more, about 5% or less, about 10% or less, about 20% or less, about 30% or less, about 40% or less, about 50% or less, about 60% or less, about 70% or less, about 80% or less, or about 90% or less compared to an untreated plant. In yet another aspect, the methods and compositions disclosed herein reduce damage caused by wire worms by about 5%, about 10%, about 20%, about 30%, about 40%, about 50%, about 60% about 70%, about 80%, or about 90% compared to an untreated plant. In yet another aspect, the above percentages apply to a method of treating wireworm infestation, a method of reducing tuber tunneling, a method of reducing tuber skin feeding damage, or a method of repelling a wireworm.

In an aspect, the methods and compositions described herein increase crop yield by about 10% to about 20%, about 10 %, about 30%, about 10% to about 40%, about 10% to about 90%, about 20% to about 80%, about 30% to about 70%, about 40% to about 60%, or about 5% or more, about 10% or more, about 20% or more, about 30% or more, about 40% or more, about 50% or more, about 60% or more, about 70% or more, about 80% or more, or about 90% or more compared to an untreated plant or crop. In yet another aspect, the methods and compositions described herein increase crop yield by about 5%, about 10%, about 20%, about 30%, about 40%, about 50%, about 60% about 70%, about 80%, or about 90% compared to an untreated plant or crop.

The compounds or compositions described herein can be used in an amount effective to control wireworms. In an aspect, a compound or composition described herein is applied at about 1.0 fluid ounces/acre to about 20.0 fluid ounces/acre, about 2.0 fluid ounces/acre to about 10.0 fluid ounces/acre, about 3.0 fluid ounces/acre to about 8.0 fluid ounces/acre, or about 4.0 fluid ounces/acre to about 6.0 fluid ounces/acre. In another aspect, a compound or composition described herein is applied at about 0.1, about 1.0, about 2.0, about 3.0, about 4.0, about 5.0, about 6.0, about 7.0, about 8.0, about 9.0, about 10.0, or about 20.0 or more fluid ounces/acre.

In an aspect, a compound or composition described herein is applied in a single application to the foliar region of a plant or crop. In another aspect, a compound or composition described herein is applied in multiple application steps to the foliar region of a plant or crop. In yet another aspect, a compound or composition described herein is applied in one, two, three, four, five, or six or more application steps to the foliar region of a plant or crop. In another aspect, a compound or composition described herein is applied in one or more soil application steps followed by one, two, three, four, five, or six or more application steps to the foliar region of a plant or crop.

In another aspect, a compound or composition described herein is applied to the foliar region of a plant or crop at about 1 to about 100 days, about 2 to about 50 days, about 10 to about 50 days, about 15 to about 40 days, about 20 to about 50 days, about 30 to about 50 days, about 40 to about 50 days, about 10 to about 40 days, about 20 to about 40 days, or about 30 to about 40 days after planting. In another aspect, a compound or composition described herein is applied to the foliar region of a plant or crop at about 1, about 5, about 10, about 15, about 20, about 25, about 30, about 35, about 40, about 45, about 50, about 75, or about 100 or more days after planting. In yet another aspect, a compound or composition described herein is applied to the foliar region of a plant or crop at least 1, at least 5, at least 10, at least 15, at least 20, at least 25, at least 30, at least 35, at least 40, at least 45, at least 50, at least 75, or at least 100 days after planting. In another aspect, more than one of the above foliar application times can be used with any of the compositions, compounds, or methods described herein. For example, a compound or composition described herein can be applied in a first foliar application at about 10 days and a second foliar application at about 20 days, a first foliar application at about 20 days and a second lobar application at about 40 days, a first foliar application at about 30 days, and a second foliar application at about 50 days, or a first foliar application at about 40 days and a second foliar application at about 50 days.

In an aspect, a compound or composition described herein is applied to the foliar region of a plant or crop in a first application step after about 35 to about 42 days or about 30 to about 50 days after planting. In another aspect, a compound or composition described herein is applied in a second foliar application step about 10 to about 15 days after the first application step. In yet another aspect, a compound or composition described herein is applied in a third foliar application step about 10 to about 15 days after a second application step. In an aspect, a compound or composition described herein is applied in a fourth foliar application step about 10 to about 15 days after the third application step. In another aspect, the compound to be applied in a foliar application is spirotetramat and the plant to be treated is a potato.

In an aspect, the uptake of a compound or composition described herein begins after about 40 days or more, about 45 days or more, or about 50 days or more after foliar application.

In an aspect, the composition described herein comprise, consists of, or consists essentially of an active agent, such as spirotetramat, together with binders, coating agents, wetting agents, buffering agents, or polysaccharides. At least one agriculturally acceptable carrier can be added to the formulation such as water, solids or dry powders. The dry powders can be derived from a variety of materials such as wood barks, calcium carbonate, gypsum, vermiculite, talc, humus, activated charcoal, and various phosphorous compounds. In an aspect, a composition described herein can include a spray or tank mix adjuvant. In another aspect, a composition described herein can include additional components, such as an insecticide, fungicide, herbicides, fertilizer, or foliar-applied fertilizers. In another aspect, compounds or compositions described herein can include methylated seed oil (“MSO”), for example MSO at 0.5% v/v. In another aspect, MSO is a tank mix adjuvant capable of being used with a compound or composition described herein.

Components of compounds and compositions described herein can be converted into the customary formulations, such as solutions, emulsions, wettable powders, suspensions, suspension concentrate, powders, dusts, pastes, soluble powders, granules, suspoemulsion concentrates, natural and synthetic materials impregnated with active compound, and ultrafine encapsulations in polymeric materials. These formulations are produced in the known manner, for example by mixing the active compound with extenders, that is, liquid solvents and/or solid carriers, optionally with the use of surfactants, that is, emulsifiers and/or dispersants and/or foam formers. Suitable extenders are, for example, water, polar and unpolar organic chemical liquids, for example from the classes of the aromatic and nonaromatic hydrocarbons (such as paraffins, alkylbenzenes, alkylnaphthalenes, chlorobenzenes), of the alcohols and polyols (which can optionally also be substituted, etherified and/or esterified), of the ketones (such as acetone, cyclohexanone), esters (including fats and oils) and (poly)ethers, of the unsubstituted and substituted amines, amides, lactams (such as N-alkylpyrrolidones) and lactones, the sulphones and sulphoxides (such as dimethyl sulphoxide).

In the case of the use of water as an extender, organic solvents can, for example, also be used as cosolvents. Liquid solvents which are suitable are mainly; aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions mineral oils and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and water.

Solid carriers which are suitable are for example, ammonium salts and ground natural minerals, such as kaolins, clays, talc, chalk, quarts, attapulgite, montmorillonite or diatomaceous earth, and ground synthetic minerals, such as highly-disperse silica, alumina and silicates; suitable solid carriers for granules are: for example crushed and fractionated natural rocks such as calcite, marble, pumice, sepiolite and dolomite, and synthetic granules of inorganic and organic meals, and granules of organic material such as sawdust, coconut shells, maize cobs and tobacco stalks; suitable emulsifiers and/or foam formers are: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates as well as protein hydrolysates; suitable dispersants are: for example lignin-sulphite waste liquors and methylcellulose.

Adhesives such as carboxymethylcellulose and natural and synthetic polymers in the form of powders, granules or latices, such as gum arabic, polyvinyl alcohol, and polyvinyl acetate, and natural phospholipids, such as cephalins and lecithins, and synthetic phospholipids, can be used in the formulations. Other additives can be mineral and vegetable oils. Colorants may be added such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

All plants and plant parts can be treated in accordance with the invention. In this context, plants are understood as meaning all plants and plant populations that are damaged by wireworms such as desired and undesired wild plants or crop plants (including naturally occurring crop plants). Crop plants can be plants which can be obtained by traditional breeding and optimization methods or by biotechnological and recombinant methods, or combinations of these methods, including the transgenic plants and including the plant varieties which are capable or not capable of being protected by Plant Breeders' Rights. Plant parts are understood as meaning ail aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

In one embodiment, plant species and plant varieties which are found in the wild or which are obtained by traditional biological breeding methods, such as hybridization or protoplast fusion, and parts of these species and varieties are treated. In a further preferred embodiment, transgenic plants and plant varieties which were obtained by recombinant methods, if appropriate in combination with traditional methods (genetically modified organisms) and their parts are treated. The terms “parts”, “parts of plants” or “plant parts” are described above.

Plants which can be treated by the methods described herein include potatoes (for example, Solanum tuberosum), sugar beet, (for example, Beta vulgaris), dry beans (for example, Vigna species or Phaseolus species), or any other plant harmed by wireworms.

The plants and their parts may be treated with the described compositions by applying the compositions directly to the plants or plant parts. In another embodiment, the plant and plant parts may be treated indirectly, for example by treating the environment or habitat in which the plant parts are exposed to. Conventional treatment methods may be used to treat the environment or habitat including dipping, spraying, fumigating, chemigating, fogging, scattering, brushing on, seed treatment, shanking or injecting.

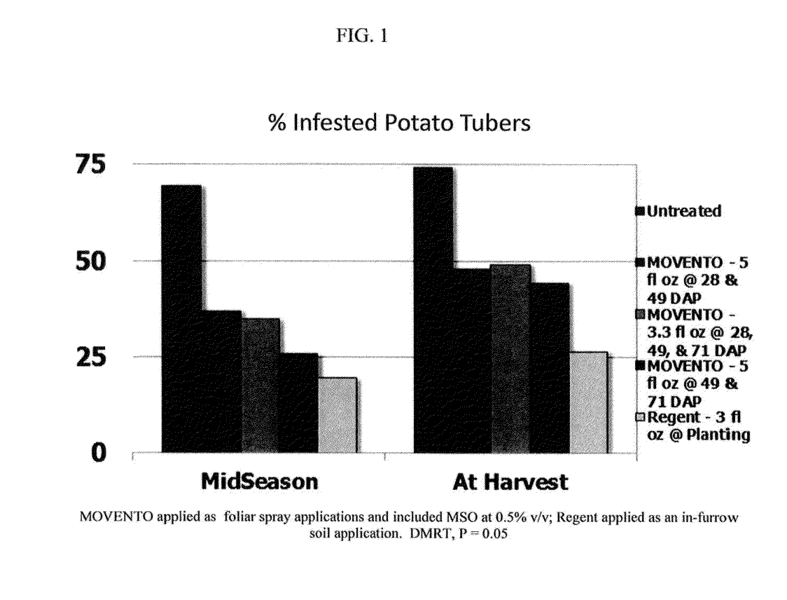

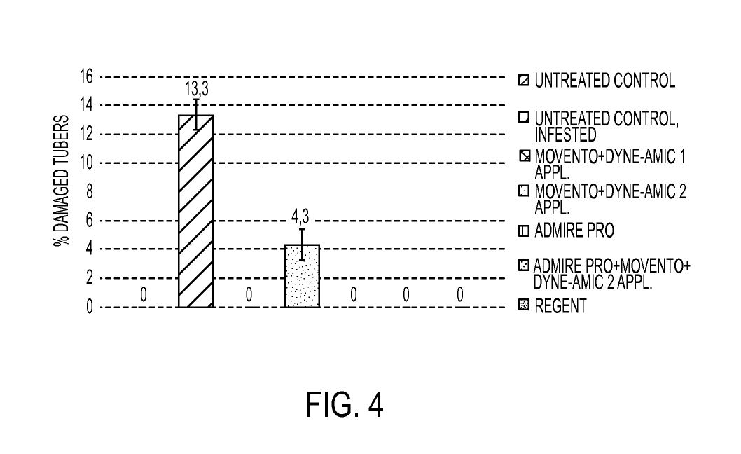

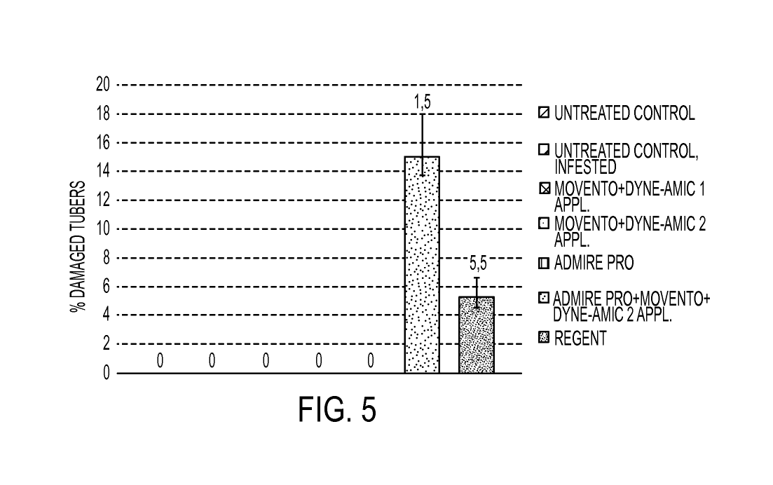

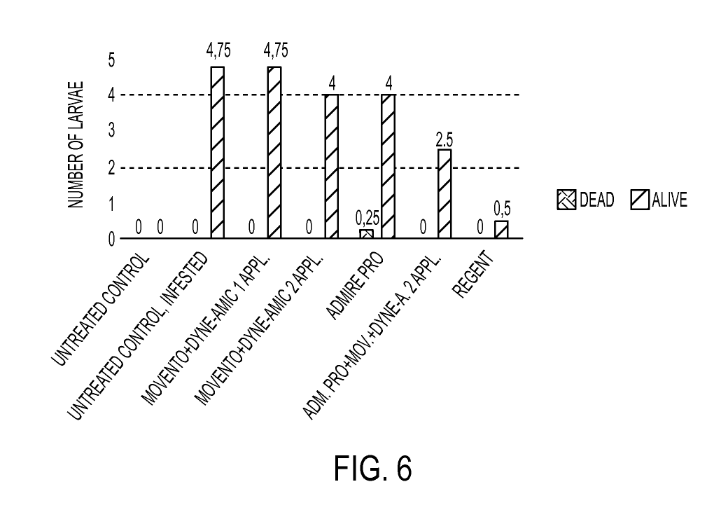

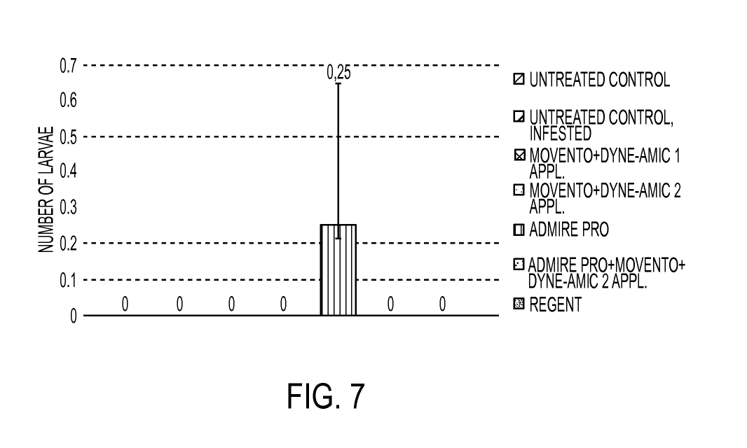

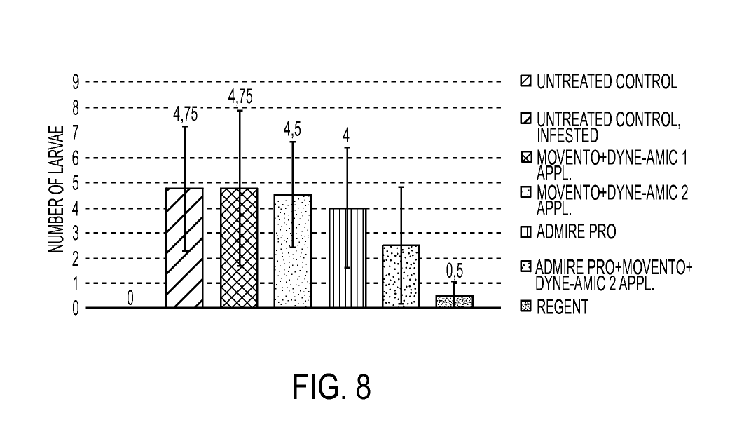

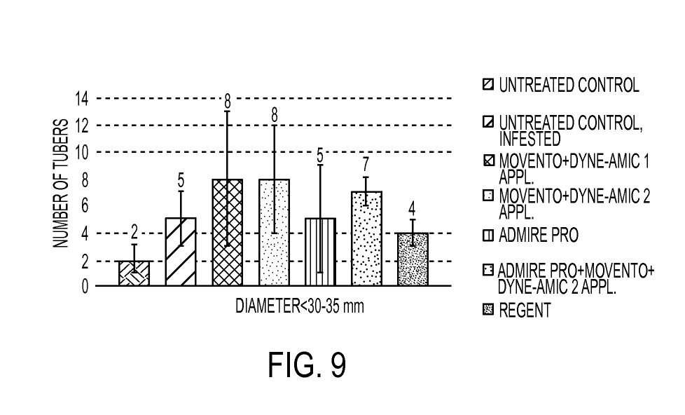

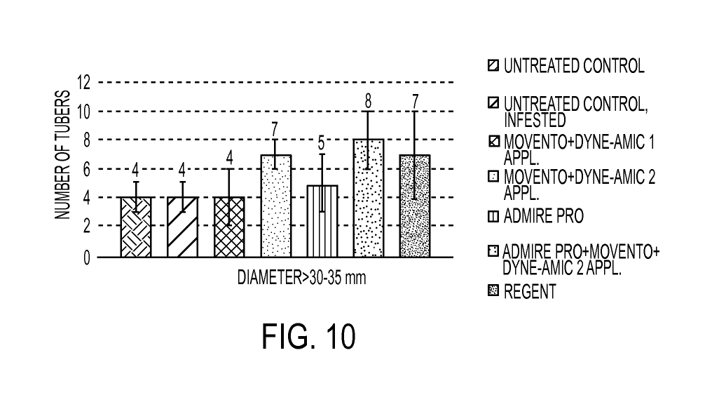

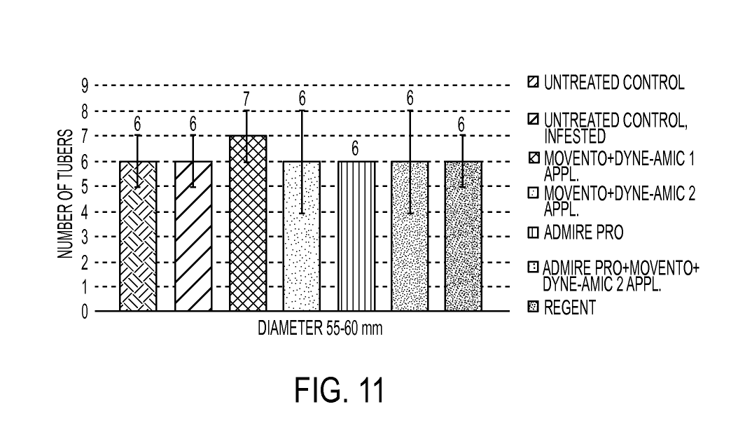

In another aspect, the disclosure provides for a kit comprising, consisting essentially of, or consisting of any of the compounds or compositions disclosed herein. In an aspect, the kit includes the combination of compounds and compositions described in Examples 1-12 and FIGS. 1-11. In another aspect, the kit provides for the compounds and compositions described in Examples 1-12 and FIGS. 1-11 applied in a manner that is consistent with the methodology of these examples and figures. In another aspect, the kit provides instructions or guidance regarding the use of the compounds, compositions, or methods described herein.

In another aspect, the kit provides that a first compound or composition is used as a soil treatment and a second compound or composition is used in a foliar treatment. In yet another aspect, the kit provides that a first compound or composition is used as a foliar treatment. In an aspect, the first and second compound or composition is the same. In another aspect, the first and second compound or composition ate different. In yet another aspect, the first compound or composition used for soil application contains imidacloprid and the second compound used for a foliar application contains spirotetramat.

In an aspect, the kit includes instructions describing the methodology described herein. In another aspect, the kit includes instructions describing the methodology set forth in Examples 1-12 and FIGS. 1-11. In an aspect, the instructions are included with the kit, separate from the kit, in the kit, or are included on the kit packaging.

The following examples serve to illustrate certain aspects of the disclosure and are not necessarily intended to limit the disclosure.

### EXAMPLES

### Example 1

Example 1 shows the experimental procedure for wireworm control in potatoes.

This example includes seven insecticide treatments replicated four times in a randomized complete block design. Table 1 sets forth the product composition and rate for each treatment. Because of the distribution of wireworm damage, each individual treatment had an untreated check including one untreated row 25 ft. long on each side. Therefore, the complete individual treatment plot includes four 25 ft. long rows (36 inch row spacing), with the two central rows treated with the insecticides and the two bordering rows left as controls. Five foot alleyways separate the plots.

Hand-cut potato seed Solanum tuberosum L., ‘Russet Burbank’ G3, was used in this example. The average weight per seed-was 2.2 oz. In-furrow at planting treatments, ADMIRE PRO, Brigadier, and Regent, were applied in a banded spray pattern with the seed pieces, using a modified CO₂ sprayer adapted to the planter with two hoses, each tipped with a nozzle at 30 PSI. Each hose was fixed in a location on the planter in such a way that a 6 inch banded spray was applied in-furrow with the seed. No insecticides were applied to the control rows.

Foliar sprays were performed with a backpack sprayer with a boom width of 36 inches each at 30 PSI. The sprayer was calibrated to release a volume of about 19 gallons per acre. No insecticides were applied to the control plots.

The center two rows and the bordering rows of each plot were harvested for damage evaluations. Fifty tubers per each 25 ft. row, for a total of 100 tubers per plot and 400 tubers per treatment, were examined for feeding damage. Fifty tubers per each check row were also examined. Tuber weight and number of external feeding sites were recorded for each tuber. For percentage of affected tubers, a tuber with one or more wireworm holes was considered an affected tuber.

The average number of holes per tuber as well as the total percentage of wireworm-damaged tubers was calculated on each treatment and compared to the damage produced on the tubers harvested from flanking control rows. Data obtained was then used in calculating “reduction in wireworm damage” for each treatment, defined as the difference between wireworm damage observed in flanking control tubers relative to tubers of the treated plots. For example, if a treatment had a mean number of holes per tuber of 0.07 (treatment 1) and the analogous value for flanking control rows was 0.11 (as shown in Table 2), the reduction in the number of tuber holes produced by wireworm feeding was=100−[(0.07*100)/0.11], which is 35.1%. The “reduction in percentage of damaged tubers” was calculated in the same manner. Therefore, if a treatment had 4.25% (treatment 1) damaged tubers and the flanking control rows had 7.75% damaged tubers (as shown in Table 2), then the reduction in percentage of damaged tubers was=100−[(4.25*100)/7.75], which is 47.74%.

Yield and grade was evaluated following the USDA standards for potatoes. Total weight of USDA #1 tubers (tubers weighing more than 114 grams, well-shaped, and up to 5% external defects were considered #1), USDA #2 (tubers weighing more than 114 grams, not seriously pointed, dumbbell-shaped or otherwise badly deformed, and no more than 6% defects were considered #2), culls (tubers badly deformed, under 114 grams or tubers 114 grams or more with knobs and/or cracks) was estimated.

The effect of each treatment on quantitative parameters (tuber weight, number of holes per tuber, and percentage of affected tubers) and qualitative parameters (USDA #1, USDA #2 and culls) are presented below. Data were analyzed using an analysis of variance. The treatment means were separated using LSD (α=0.05). Statistical analyses were performed in Statistix using Proc GLM (version 9).

Table 1. Insecticide treatment list with rates and application timing.

TABLE 1

| Wireworm | | Form | | Transf. | | | |
|---|---|---|---|---|---|---|---|
| Treatment | Description | Type | Rate | Dosage | | Timing | |
| 1 | Admire Pro Movento 240 + | SC | fl oz/a fl | | | | |
| | MSO Movento 240 + MSO | SC | oz/a % | 8.7 | 5 | IFAP Foliar (5-6 wk after | |
| | | SC | v/v fl | 0.5 | 5 | planting) | |
| | | | oz/a % | 0.5 | | Foliar (10-14 days later) | |
| | | | v/v | | | | |
| 2 | Movento 240 + MSO | SC | fl oz/a | | | | |
| | Movento 240 + MSO | SC | % v/v | | | | |
| | Movento 240 + MSO | SC | fl oz/a % | 5 | 0.5 | Foliar (5-6 wk after | |
| | Movento 240 + MSO | SC | v/v fl | 5 | 0.5 | planting) | |
| | | | oz/a % | 5 | 0.5 | Foliar (10-14 days later) | |
| | | | v/v fl | 5 | 0.5 | Foliar (10-14 days later) | |
| | | | oz/a % | | | Foliar (10-14 days later) | |
| | | | v/v | | | | |
| 3 | Movento 240 + MSO | SC | fl oz/a fl | | | | |
| | Movento 240 + MSO | SC | oz/a % | 5 | 0.5 | Foliar (5-6 wk after | |
| | | | v/v fl | 5 | 0.5 | planting) | |
| | | | oz/a % | | | Foliar (10-14 days later) | |
| | | | v/v | | | | |
| 4 | Brigadier 2SC | SC | fl oz/a | 16.00 | | IFAP | |
| 5 | Brigadier 2SC Admire Pro | SC | fl oz/a | 24 | 3.48 | IFAP | IFAP |
| | | SC | fl oz/a | | | | |

| | | | | | |
|---|---|---|---|---|---|
| 6 | Admire Pro | SC | fl oz/a | 8.70 | IFAP |
| 7 | Regent | WG | fl z/a | 3.20 | IFAP |

IFAP refers to In-Furrow At-Planting
WG refers to wettable granule
SC refers to suspension concentrate

### Example 2

Tuber damage results and conclusions.

The mean number of holes per tuber and percentage of affected tubers, in the treated and untreated rows are presented in Table 2. The reduction in wireworm damage and percentage of affected tubers are also included in Table 2. Tubers from treatment 6 (Admire Pro) had more average holes per tuber than any other treatment. Tubers from treatment 2 (representing four foliar applications of Movento) had the lowest number of holes per tuber. The control rows flanking treatment 4 (Brigadier) presented the highest average number of holes per tuber.

Results for percentage of tubers affected.

One single hole In a tuber indicates an affected tuber. The lowest percentage of affected tubers was observed in treatments 2 (four foliar applications of Movento), 3 (two foliar applications of Movento), and 7 (Regent). The control rows flanking treatment 5 (Brigadier+Admire Pro) presented the highest percentage of affected tubers. The highest reduction in the percentage of affected tubers was in treatment 5 (Brigadier+Admire Pro).

Table 2 shows the effect of several insecticide treatments at reducing wireworm damage.

TABLE 2

| | | | | | | % | |
|---|---|---|---|---|---|---|---|
| | | | Holes/ | | | Affected | Reduction |
| | | | tuber in | Reduction | % | Tubers in | of |
| Wireworm | | Holes/ | associated | in | Affected | associated | affected |
| Treatment | Description | tuber | control | damage | Tubers | control | tubers |
| 1 | Admire Pro | 0.07 | 0.11 | 35.10 | 4.25 | 7.75 | 47.74 |
| | Movento | | | | | | |
| | 240 + MSO | | | | | | |
| | Movento | | | | | | |
| | 240 + MSO | | | | | | |
| 2 | Movento | 0.035 | 0.185 | 76.16 | 3.25 | 9.25 | 56.62 |
| | 240 + MSO | | | | | | |
| | Movento | | | | | | |
| | 240 + MSO | | | | | | |
| | Movento | | | | | | |
| | 240 + MSO | | | | | | |
| | Movento | | | | | | |
| | 240 + MSO | | | | | | |
| 3 | Movento | 0.04 | 0.12 | 67.30 | 3.25 | 8 | 63.13 |
| | 240 + MSO | | | | | | |
| | Movento | | | | | | |
| | 240 + MSO | | | | | | |
| 4 | Brigadier | 0.055 | 0.195 | 69.20 | 4.5 | 10.75 | 57.58 |
| | 2SC | | | | | | |
| 5 | Brigadier | 0.043 | 0.18 | 72.49 | 3.5 | 11.25 | 64.47 |
| | 2SC | | | | | | |
| | Admire Pro | | | | | | |
| 6 | Admire Pro | 0.11 | 0.12 | 13.05 | 6.25 | 8.5 | 23.89 |
| 7 | Regent | 0.052 | 0.133 | 64.83 | 3.25 | 8.75 | 61.61 |

### Example 3

Tuber weight results.

The average weight per tuber in treated and untreated rows is included in Table 3. The lowest average tuber weight was recorded in T3 (two foliar applications of Movento) and the highest average tuber weight was recorded in T7 (Regent).

Average tuber weight in individual treatments and untreated flanking rows.

TABLE 3

| | | | Weight/ |
|---|---|---|---|
| | | | tuber in |
| Wireworm | | Weight/ | associated |
| Treatment | Description | tuber | control |
| 1 | Admire Pro Movento 240 + MSO | 194.96 | 187.12 |
| | Movento 240 + MSO | | |
| 2 | Movento 240 + MSO Movento 240 + | 188.12 | 205.93 |
| | MSO Movento 240 + MSO | | |
| | Movento 240 + MSO | | |
| 3 | Movento 240 + MSO Movento 240 + | 173.43 | 207.42 |
| | MSO | | |
| 4 | Brigadier 2SC | 180.68 | 198.9 |
| 5 | Brigadier 2SC Admire Pro | 192.54 | 195.51 |
| 6 | Admire Pro | 185.35 | 209 |
| 7 | Regent | 202.95 | 196.69 |

### Example 4

Yield and grade results.

The total weight of USDA #1 and USDA #2 tubers, culls and total yield per treatment are included in Table 4. Treatment 1 (Admire Pro+two foliar applications of Movento) had the highest yield of USDA #1 tubers. The Brigadier treated plots (T4) had the lowest yield of USDA #1 and Treatment 5 (Brigadier+Admire Pro) presented the highest yield of USDA #2 tubers.

Yield and grade table.

TABLE 4

| | | | | | Total |
|---|---|---|---|---|---|
| Treatment | | USDA #1 | USDA #2 | Culls | Wt. |
| 1 | Admire Pro Movento 240 + | 194.3a | 54.1 | 86.3 | 334.7 |
| | MSO Movento 240 + | | | | |
| | MSO | | | | |
| 2 | Movento 240 + MSO | 170.5ab | 53.2 | 97.4 | 321.1 |
| | Movento 240 + MSO | | | | |
| | Movento 240 + MSO | | | | |
| | Movento 240 + MSO | | | | |
| 3 | Movento 240 + MSO | 194.1a | 57.3 | 106.7 | 358.1 |
| | Movento 240 + MSO | | | | |
| 4 | Brigadier 2SC | 141.8b | 63.2 | 105.5 | 310.5 |
| 5 | Brigadier 2SC Admire | 180.6ab | 73.3 | 94.9 | 348.8 |
| | Pro | | | | |
| 6 | Admire Pro | 158.5ab | 70.6 | 99.7 | 328.8 |
| 7 | Regent | 188.5ab | 63.1 | 95.7 | 347.3 |

Total yields in pounds
USDA #1 tubers; tubers weighing more than 114 grams and up to 6% external defects were considered # 1)
USDA #2 (tubers weighing more than 114 grams and more than 6% defects were considered # 2)
Culls (tubers under 114 grams or tubers 114 grams or more with knobs and/or cracks) USDA # 2
potatoes have more than two (2) defects (Two knobs and a crack, etc.).

### Example 5

Treatment 2 (four foliar applications of Movento) in Tables 1-4 reduced the average number of holes per tuber by 76%. Treatment 5 (Brigadier+Admire Fro) in Tables 1-4 presented the highest reduction in the percentage of affected tubers. Treatment 1 (Admire Pro+two foliar applications of Movento) in Tables 1-4 had the highest yield of USDA #1 tubers. Treatment 7 (Regent) in Tables 1-4 had the highest average weight per tuber. However, the average tuber weight was not significantly different to the one in treatments 2 and 5.

### Example 6

Experimental procedure for determining the efficacy of various chemical treatments on wire-worm in potatoes grown in Washington State, United States.

Potato seed Solarium tuberosum L., ‘Russet Burbank’ was used in this experiment. Seeds were planted at a depth of 8 inches with spacing within the row at 10 inches and between rows at 34 inches. The experimental site was a 12 ft. by 20 ft. plot containing four experimental replications.

In this example application of chemicals was done according to the manner shown in Table 5.

TABLE 5

| | A | | B | | C | | D | |
|---|---|---|---|---|---|---|---|---|
| Application Method: | SPRAY | | SPRAY | | SPRAY | | SPRAY | |
| Application Timing: | At planting | | Post-emergent | | Post-emergent | | Post-emergent | |
| | | | application | | application | | application | |
| Application Placement: | INFURR | | SOIL | | SOIL | | SOIL | |
| Air Temperature, Unit: | 65 | F. | 68 | F. | 70 | F. | 62 | F. |
| % Relative Humidity: | 55 | | 45 | | 53 | | 42 | |
| Wind Velocity, Unit: | 0 | MPH | 3.6 | MPH | 12.5 | MPH | 3.0 | MPH |

| | | | | |
|---|---|---|---|---|
| Wind Direction: | | SW | SW | SW |
| Dew Presence (Y/N): | N | N | N | N |
| Soil Moisture: | NORMAL | NORMAL | NORMAL | NORMAL |
| % Cloud Cover: | 0 | 0 | 0 | 0 |

Application equipment used in this example is provided in Table 6.

TABLE 6

| | A | | B | | C | | D | |
|---|---|---|---|---|---|---|---|---|
| Appl. Equipment: | PLANTER | | Backpack | | Backpack | | Backpack | |
| Equipment Type: | | | CO2 BP | | CO2 BP | | CO2 BP | |
| Operating Pressure, | 20 | PSI | 30 | psi | 30 | psi | 30 | psi |
| Unit: | | | | | | | | |
| Nozzle Type: | FLAT FAN | | flat fan | | flat fan | | flat fan | |
| Nozzle Size: | 80015VS | | 8003VS | | 8003VS | | 8003VS | |
| Nozzle Spacing, Unit: | 34 | IN | 18 | in | 18 | in | 18 | in |
| Nozzles/Row: | 4 | | 4 | | 4 | | 4 | |
| Band Width, Unit: | 6 | IN | 6 | ft | 6 | ft | 6 | ft |
| Boom Length, Unit: | | | 4.5 | FT | 4.5 | FT | 4.5 | FT |
| Ground Speed, Unit: | 2.13 | MPH | 3.2 | mph | 3.2 | mph | 3.2 | mph |
| Carrier: | WATER | | WATER | | WATER | | WATER | |
| Spray Volume, Unit: | 5 | GPA | 20 | gal/ac | 20 | gal/ac | 20 | gal/ac |
| Mix Size, Unit: | 2 | GAL | 2 | liters | 2 | liters | 2 | liters |

| | | | | |
|---|---|---|---|---|
| Propellant: | CO2 | CO2 | CO2 | CO2 |
| Tank Mix (Y/N): | N no | | | |

An example trial protocol is summarized in Table 7.

TABLE 7

| Trt | Treatment | Other | Other | Appl |
|---|---|---|---|---|
| No. | Name | Rate | Rate Unit | Code |
| 1 | UNTREATED | | | |
| | CHECK | | | |
| 2 | REGENT | 3.0 | FL OZ/A | A |
| 15 | MOVENTO | 5.0 | FL OZ/A | BC |
| | MSO | 0.5 | % V/V | BC |
| 16 | MOVENTO | 3.3 | FL OZ/A | BCD |
| | MSO | 0.5 | % V/V | BCD |
| 17 | MOVENTO | 5.0 | FL OZ/A | CD |
| | MSO | 0.5 | % V/V | CD |

A = at planting; B = 42 days after planting; C = 49 days after planting; D = 68 days after planting; E = 82 days after planting

### Example 7

Experimental results presented in FIG. 1 shows the efficacy of various chemical treatments on wireworm in potatoes grown in Washington State, United States as reported in percentage of infested tubers.

Experimental data supporting FIG. 1 is shown in Table 8.

TABLE 8

| Crop Code | | | | | SOLTU | SOLTU |
|---|---|---|---|---|---|---|
| BBCH Scale | | | | | BPOT | BPOT |
| Crop Scientfic Name | | | | | Solanum tuberosum | Solanum tuberosum |
| Crop Name | | | | | Potato | Potato |
| Crop Variety | | | | | Russet Burbank | Russet Burbank |
| Part Rated | | | | | TUBER C | TUBER C |
| Rating Type | | | | | PESINC | PESINC |
| Rating Unit | | | | | % | % |
| Number of Subsamples | | | | | 1 | 1 |
| Trt | Treatment | Other | Other | Appl | | |
| No. | Name | Rate | Rate Unit | Code | 1 | 3 |
| 1 | UNTREATED CHECK | | | | 69.5 | 74.3 |
| 2 | REGENT | 3.0 | FL OZ/A | A | 19.5 | 26.5 |
| 15 | MOVENTO | 5.0 | FL OZ/A | BC | 37.0 | 48.0 |
| | MSO | 0.5 | % V/V | BC | | |
| 16 | MOVENTO | 3.3 | FL OZ/A | BCD | 34.8 | 49.0 |
| | MSO | 0.5 | % V/V | BCD | | |
| 17 | MOVENTO | 5.0 | FL OZ/A | CD | 25.8 | 44.3 |
| | MSO | 0.5 | % V/V | CD | | |
| LSD (P = .05) | | | | | 17.50 | 27.31 |
| Standard Deviation | | | | | 11.36 | 17.72 |
| CV | | | | | 30.45 | 36.62 |

PESINC refers to the percent of potatoes exhibiting wireworm damage

### Example 8

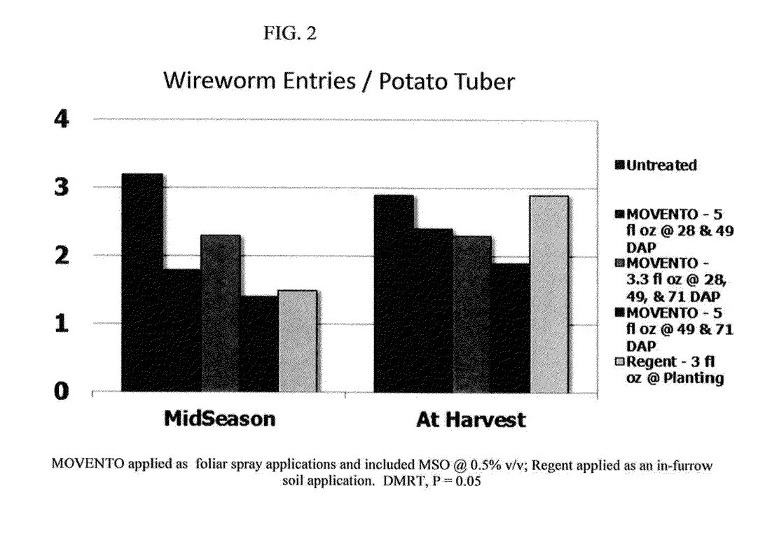

Experimental results presented in FIG. 2 shows the efficacy of various products on wireworm in potatoes grown in Washington State, United States as reported in wireworms entries per tuber.

Experimental data supporting FIG. 2 is shown in Table 9.

TABLE 9

| Crop Code | | | | | SOLTU | SOLTU |
|---|---|---|---|---|---|---|
| BBCH Scale | | | | | BPOT | BPOT |
| Crop Scientfic Name | | | | | Solanum tuberosum | Solanum tuberosum |
| Crop Name | | | | | Potato | Potato |
| Crop Variety | | | | | Russet Burbank | Russet Burbank |
| Part Rated | | | | | TUBER C | TUBER C |
| Rating Type | | | | | PESSEV | PESSEV |
| Rating Unit | | | | | NUMBER | NUMBER |
| Number of Subsamples | | | | | 100 | 100 |
| Trt | Treatment | Other | Other | Appl | | |
| No. | Name | Rate | Rate Unit | Code | 2 | 4 |
| 1 | UNTREATED CHECK | | | | 3.2 | 2.9 |
| 2 | REGENT | 3.0 | FL OZ/A | A | 1.5 | 2.8 |
| 15 | MOVENTO | 5.0 | FL OZ/A | BC | 1.8 | 2.4 |
| | MSO | 0.5 | % V/V | BC | | |
| 16 | MOVENTO | 3.3 | FL OZ/A | BCD | 2.3 | 2.3 |
| | MSO | 0.5 | % V/V | BCD | | |
| 17 | MOVENTO | 5.0 | FL OZ/A | CD | 1.4 | 1.9 |
| | MSO | 0.5 | % V/V | CD | | |
| LSD (P = .05) | | | | | 0.91 | 1.10 |
| Standard Deviation | | | | | 0.59 | 0.72 |
| CV | | | | | 28.93 | 29.14 |

### Example 9

Foliar treatments of Movento were applied on potatoes to determine wireworm efficacy. Two sequential programs were tested. The first program was applied starting at about 5 to 6 weeks after planting with a repeat application 10 to 14 days later. The second program includes the first program-plus additional Movento treatments applied after 10 to 14 days and again 10 to 14 days later. Admire Pro was also tested alone and in combination with the early Movento program. Movento was applied at 5 fl oz/A with MSO at 0.5% v/v. Regent (fipronil) was the standard wireworm comparison. Each plot was four rows wide. The two center rows were treated with insecticide and the two bordering rows on each side were untreated. Admire Pro presided suppression of wireworm damage on daughter tubers (24%). Movento applied early was as effective as the wireworm standard (Regent) in reducing damage (63% reduction).

### Example 10

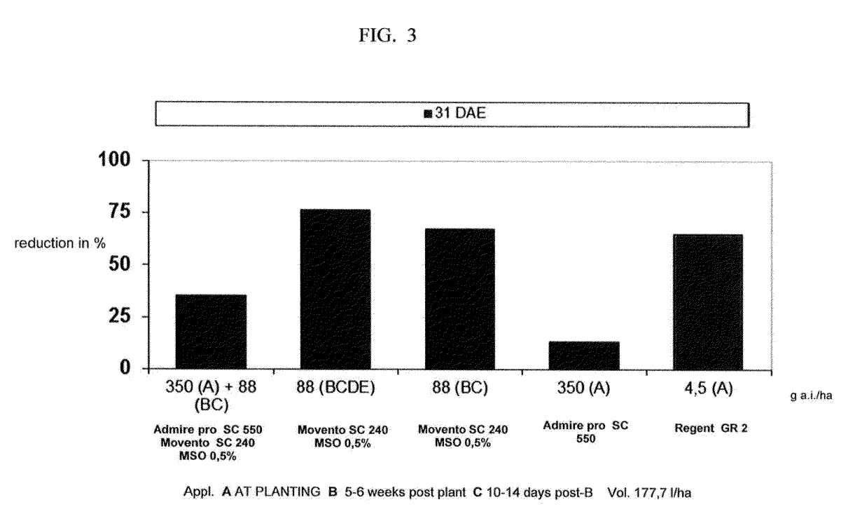

Experimental results are presented in FIG. 3 showing the percent reduction in wireworm infestation of potatoes treated with various chemicals under certain time conditions. The experimental results set forth in FIG. 3 further confirm the efficacy of spirotetramat in treating wire worms in potato.

### Example 11

Movento efficacy in potatoes against wireworms was tested in greenhouse trials. Table 10 shows an example greenhouse trial plan.

TABLE 10

| | | | | Rate mL | rate | | | |
|---|---|---|---|---|---|---|---|---|
| | Treatment | Fl | Spec | product/ha | g [symbol] /ha | Spray timing | Infestation | Remarks |
| 1 | Untreated | | | | | | | |
| 2 | Untreated infested | | | | | | BBCH 13 | |
| 3 | Movento + Dyne-Amic | SC 240 + | | 365 + 1250 | 88 + 1250 | beginning of tuber | BBCH 13 | US recom max |
| | | 100% | | | | formation BBCH 59 | | 5 pints/100 |
| | | | | | | 5-6 weeks after | | gallons = 2365 [symbol] |
| | | | | | | planting | | |
| 4 | Movento + Dyne-Amic | SC 245 + | | 365 + 1250 | 88 + 1250 | 1. appl. beginning of | BBCH 13 | |
| | | 100% | | | | tuber formation BBCH 59 | | |
| | | | | | | 5-6 weeks after planting | | |
| | | | | | | 2. appl. 10-14 days | | |
| | | | | | | after beginning of tuber | | |
| | | | | | | formation BBCH 59 | | |
| 5 | Admire Pro | SC 550 | | 603 | 335 | IFAP at planting | BBCH 13 | 8.7 ft oz/ [symbol] IFAP = |
| | | | | | | | | 556 microliter SC 550/m |
| | | | | | | | | row at 36 inch row |
| | | | | | | | | spacing at 5-10 cm |
| | | | | | | | | band width |
| 6 | Admire Pro u. Movento + | SC 550 | | 609 | 335 | Admire Pro IFAP at | BBCH 13 | 8 7 fl. oz/ [symbol] |
| | Dyne-Amic | SC 240 + | | 365 + 1250 | 86 + 1250 | planting Movento + | | |
| | | 100% | | | | Dyne-Amic application | | |
| | | | | | | according label. | | |
| | | | | | | 1. appl. beginning of | | |
| | | | | | | tuber formation BBCH | | |
| | | | | | | 59 6-6 weeks after | | |
| | | | | | | planting 2 appl. 10-14 | | |
| | | | | | | days after beginning of | | |
| | | | | | | tuber formation BBCH 59 | | |
| 7 | Regent | SC4 × 478 0 | | 224 | 107.5 | IFAP at planting | BBCH 13 | 3.2 fl. oz/ac IFAP = |
| | | Fi [symbol] | | | | | | 202 microliter SC4/m |
| | | | | | | | | row at 36 inch row |
| | | | | | | | | spacing and 10 (adapted |
| | | | | | | | | to Admire [symbol] |
| | | | | | | | | 12.7-17.78 cm band |
| | | | | | | | | width |

[symbol]

indicates data missing or illegible when filed

Representative parameters for the trials set in Table 10 are as follows: PVC pot size of 20 L (0.091 m² upper soil surface area; pot height: 24 cm), draining holes closed to prevent escaping of wireworms
Soil volume/pot ratio of 19 L total
10 L unfertilized bottom soil filled 11 cm below pot curb
   4 L fertilized soil to form planting furrow 4 cm below pot curb
   4 L fertilized top soil to fill up furrow 2 cm below pot curb
Fertilization: 10.47 g ENTEC perfect per pot equiv. to 160 kg N/ha
   N—P—K—Mg—S—B—Zn: 14-7-17-2-10-0.02-0.01%
Soil type; sandy loam Laacherhof
Soil water conditions: 60-70% who (Water Holding Capacity)
Irrigation; hand watering and drip tubes
Furrow area 0,34 m×0,1 m=0,034 m²
   136 ml application volume equiv. to IFAP water volume: 37.9 L=10 gal./ac. application via Desaga Lab Sprayer
Planting depth: 10 cm
Replicates: 4 pots
Cv: early season potatoes; e.g. Holländische Erstlinge
Tubers/pot: 1; pregerminated at 15° C. (start 30.3.2011)
Larvae/pot: 10 introduced at planting depth (Dutch and French sources) equiv. to approx. 110 larvae/m²; 1.1 mio larvae/ha
° C.: 20 day; 15 night

% r,h: 70-80
Light: 12 h Na-vapour lamps

### Example 12

Results from the greenhouse trial suggest a number of conclusions. The data confirm a significant reduction of tuber tunneling and tuber skin feeding damages following Movento treatments 44 and 58 days after planting (28 and 42 days alter infestation); 2 applications of Movento did not improve efficacy; the number of recovered living larvae in Movento treated potatoes was comparable to untreated, pointing to an anti-feeding effect or repellency; Admire Pro followed by Movento sequences and Regent treatments showed noticeable tuber skin feeding damages but no tuber tunneling.

What is claimed is:

1. A method for reducing or inhibiting Coleoptera pest damage to a crop susceptible to Coleoptera pest damage comprising applying spirotetramat to a crop susceptible to Coleoptera pest damage.

2. The method of claim 1, wherein said spirotetramat is applied to a foliar region of said crop susceptible to Coleoptera pest damage.

3. The method of claim 1, wherein said crop susceptible to Coleoptera pest damage is selected from the group consisting of potatoes, sugar beets, and dry beans.

4. The method of claim 1, wherein said spirotetramat is applied to said crop susceptible to Coleoptera pest damage by spraying, fumigating, chemigating, fogging, scattering, brushing on, seed treatment, shanking or injecting.

5. The method of claim 1, wherein said spirotetramat is applied in a single application step alter about 20 days of planting.

6. The method of claim 1, wherein said spirotetramat is applied in multiple application steps after about 20 days of planting.

7. The method of claim 1, wherein said spirotetramat is applied to a potato in an amount effective to control wire worms.

8. The method of claim 1, wherein said spirotetramat is applied to a potato at about 3 to about 10 fluid ounces per acre.

9. The method of claim 1, wherein said spirotetramat is applied to a potato at about 4 to about 6 fluid ounces per acre and said Coleoptera pest is a wire-worm.

10. A method for repelling a Coleoptera pest comprising applying spirotetramat to a crop susceptible to Coleoptera pest damage.

11. The method of claim 10, wherein said spirotetramat is applied to a foliar region of said crop susceptible to Coleoptera pest damage.

12. The method of claim 10, wherein said crop susceptible to Coleoptera pest damage is selected from the group consisting of potatoes, sugar beets, and dry beans.

13. The method of claim 10, wherein said spirotetramat is applied to said crop susceptible to Coleoptera pest damage by spraying, fumigating, chemigating, fogging, scattering, brushing on, seed treatment, shanking or injecting.

14. The method of claim 10, wherein said spirotetramat is applied in a single application step after about 20 days of planting.

15. The method of claim 10, wherein said spirotetramat is applied in multiple application steps after about 20 days of planting.

16. The method of claim 10, wherein said spirotetramat is applied to a potato in an amount effective to control wire worms.

17. The method of claim 10, wherein said spirotetramat is applied to a potato at about 3 to about 10 fluid ounces per acre.

18. The method of claim 10, wherein said spirotetramat is applied to a potato at about 4 to about 6 fluid ounces per acre and said Coleoptera pest is a wireworm.

19. A method for increasing potato yield by applying a composition comprising spirotetramat to a potato, wherein said composition repels wireworms.

20. The method of claim 19, wherein said composition is applied to a foliar region of a potato.
